(19) United States
(12) Patent Application Publication
(10) Pub. No.: US 2009/0193190 A1
(43) Pub. Date: Jul. 30, 2009

(54) Memory Card and Accessing Method and Accessing System for the same

(76) Inventors: HSUAN-LUNG HSU, Hsin-Chu (TW); Yung-Chih Chen, Hsin-Chu (TW); Chun-Hsien Lin, Hsin-Chu (TW); Chi-Chin Chen, Hsin-Chu (TW)

Correspondence Address: HDLS Patent & Trademark Services, P.O. BOX 220746, CHANTILLY, VA, 20153-0746, US

(21) Appl. No.: 12/169,672

(22) Filed: Jul. 9, 2008

(30) Foreign Application Priority Data
Jan. 30, 2008 (TW) 097103602

(51) Int. Cl. G06F 12/00

(52) U.S. Cl. 711/115; 711/E12.008

(57) ABSTRACT

In a memory card and accessing method and accessing system for the memory card, the accessing method and accessing system are adapted to data access between a memory card and a machine using a first operation system. The accessing method firstly checks whether the data in the memory card is stored according to a data storage type supporting both the first operation system and a second operation system. When the data is not stored according to the data storage type, the machine is prohibited from accessing the memory card. A version value is stored in the memory card, wherein the version value is a value different from a predetermined version value. The second operation system deems the memory card un-accessible when the version value is confirmed to be not the predetermined version value.

### BACKGROUND

1. Technical Field

The present invention generally relates to memory cards and accessing methods and accessing systems for the same and, more particularly, to a memory card which is limited to be accessed by a special machine and an accessing method and an accessing system for the same.

2. Description of the Related Art

Nowadays, information is widely spread in the society, and how to conveniently carry the information for use in various different circumstances has become a focus of attention of people. In order to achieve the purpose of conveniently carrying the information, many kinds of related technologies have been widely used. The related technologies are directed to portable computers, universal serial bus (USB) hard disks, and various types of memory cards and so on and rapidly developed to meet people's various different needs.

In the above-mentioned technologies, although a memory card generally has a storage capacity smaller than that of a portable computer and a USB hard disk; it is undoubtedly that the memory card is one type of portable storage media relatively most easy to carry. Furthermore, a ratio of a volume to the storage capacity of the memory card is continuously decreased.

However, with the widespread use of the memory cards, information abuse and security issues are raised. A memory card which has large amounts of data stored therein facilitates the user to carry large amounts of information, but also runs the risk of data leak in case of the memory card is lost. The risk of data leak generally results from the data accesses of most memory cards do not have any limitation, so that once the memory card is lost, the person who picks up the lost memory card may easily acquire the information stored in the memory card through an arbitrary machine.

### BRIEF SUMMARY

The present invention is to provide a memory card accessing method that is able to avoid a memory card to be accessed by an arbitrary machine.

The present invention is to further provide a memory card accessing system that is able to make a special memory card only to be accessed by a special machine.

The present invention is to still further provide a memory card that is able to reduce the risk of data leak resulting from the stored data being arbitrarily accessed.

In order to achieve the above-mentioned objects, a memory card accessing method in accordance with an embodiment of the present invention is provided. The memory card accessing method is adapted to a machine using a first operating system. The memory card accessing method firstly checks whether data in the memory card is stored according to a data storage type supporting both the first operating system and a second operating system. When the data in the memory card is confirmed not to be stored according to the data storage type, the machine is prohibited from accessing the data stored in the memory card. In addition, a version value is stored in the memory card, and the version value is a value different from a predetermined version value. When the version value is confirmed to be different from the predetermined version value, the second operating system deems the memory card un-accessible.

In one embodiment, when the machine is permitted to access the data stored in the memory card, the memory card accessing method further performs a logic operation to the data stored in a file allocation table of the memory card so as to obtain a decoded file allocation table via conversion, and then accesses the memory card based on the data in the decoded file allocation table.

A memory card accessing system in accordance with another embodiment of the present invention is provided. The memory card accessing system includes a memory card and a machine. Data in the memory card is stored according to a data storage type supporting a first operating system. The memory card has a first identification code stored therein. The machine uses the first operating system. The machine includes a software storage region for storing software which is for performing data access function to an external memory device, an identification data storage region for storing an identification data associated with the machine, and a processing unit. The processing unit is used for performing the first operating system and the software to acquire the first identification code from the memory card and a second identification code from the identification data and then determining the machine whether accesses the memory card according to whether the first identification code and the second identification code satisfy a first predetermined relationship.

A memory card in accordance with still another embodiment of the present invention is provided. The memory card is adapted to insert into a machine for accessing data stored in the memory card. The data in the memory card is stored according to a data storage type supporting a first operating system. It is characterized in that the memory card has an identification data stored therein. The identification data is read by the machine to compare with a machine identification data stored in the machine, when the memory card is inserted into the machine. The memory card permits to be accessed by the machine, when the identification data and the machine identification data satisfy a predetermined relationship.

In one embodiment, the identification data stored in the memory card includes a version value. When the version value is different from a predetermined version value, the operating system deems the memory card as an un-accessible memory media.

In another one embodiment, the memory card includes a data storage area for storing a file and a file allocation table for storing a storage location of the file in the data storage area. The storage location of the file in the data storage area which is stored in the file allocation table is different from an actual storage location of the file in the data storage area and determined by a special logic operation.

In the various embodiments of the present invention, since the machine and the memory card are provided with special identification data for comparison, the memory card only permits to be accessed by a special machine. Correspondingly, the machine also only accesses some special memory cards. Therefore, due to the memory card is prevented from being accessed by an arbitrary machine, the risk of data leak for the memory card would be greatly reduced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of a memory space configuration in a memory card, in accordance with an embodiment of the present invention.

FIG. 2 is a schematic system block diagram of a memory card accessing system, in accordance with another embodiment of the present invention.

FIG. 3 is a flow chart of a memory card accessing method, in accordance with still another embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

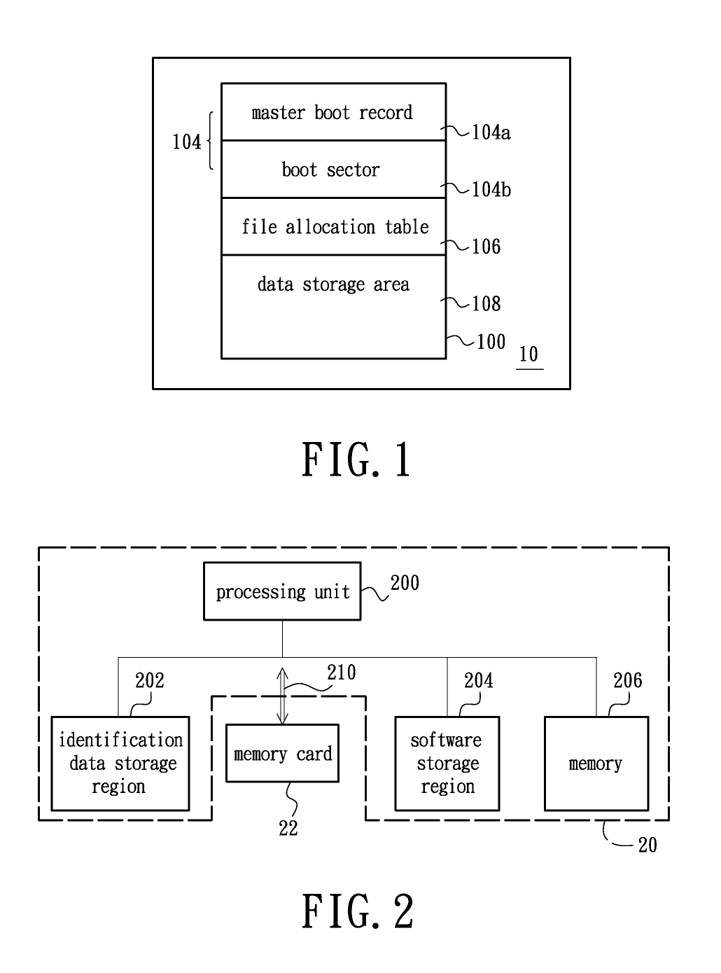

FIG. 1 is a schematic diagram of a memory space configuration in a memory card in accordance with an embodiment of the present invention. As illustrated in FIG. 1, the memory card 10 includes a memory space 100 essentially constituted by memories (generally flash memories, e.g., NAND flash memories). In order to store data, the memory space 100 is formatted according to an operating system to which the memory card 10 adapted. In another words, the memory space 100 is processed according to a data storage type compatible with the operating system to which the memory card 10 adapted. For example, when the operating system to which the memory card 10 adapted is a windows operating system, the memory space 100 is processed according to FAT32 storage type and thereby is divided into three blocks of a boot area 104, a file allocation table 106 and a data storage area 108. In one embodiment, the boot area 104 may include a master boot record 104a and a boot sector 104b. The boot area 104 is used for storing data associated with system boot. In particular, the boot area 104 includes a plurality of parameter storage sections for storing values of a plurality of parameters. At least one of the parameters is used for identifying whether the data in the memory card 10 is stored according to the FAT32 storage type. For example, the boot area 104 may include a file system type storage section for storing a file system type value, a version storage section for storing a version value, and a reserved storage section without storing any parameter. These storage sections of the boot area 104 are distinguished from one another according to respective byte offsets and lengths. The data storage area 108 is used for storing various types of files and documents. The file allocation table 106 is used for storing storage locations of the files and documents in the data storage area 108.

In the present embodiment, the memory card 10 has a group of identification data stored in the boot area 104. The group of identification data is read out when the memory card 10 is inserted into a machine, to compare with a corresponding machine identification data (which is described below in detail) stored in the machine. Only if the identification data stored in the memory card 10 and the machine identification data stored in the machine are confirmed to satisfy a predetermined relationship (e.g., are identical with each other) after comparison, the memory card 10 permits to be accessed by the machine.

In practical applications, in the memory card 10, the identification data may be an identification code stored in the parameter storage section of the boot area 104, a version value stored in the version storage section of the boot area 104, or even both the identification code and the version value.

It is indicated that the version value in the FAT32 storage type has its specific use, taking a windows operating system as an example, a memory card which is deemed by the windows operating system as being formatted in the FAT32 storage type, a predetermined value of the version value thereof is zero. The windows operating system checks all the values of the parameters stored in the boot area 104, as long as a value of any one of the parameters stored in the boot area 104 is different from the predetermined value of the FAT32 storage type, the windows operating system deems the data storage area 108 being unformatted. For example, the windows operating system checks the version value stored in the boot area 104 of the memory card 10, if the version value stored in the boot area 104 is zero, the windows operating system continues to check the values of the other parameters whether are respective predetermined values of the parameters of the FAT32 storage type after confirming the version value is zero. By way of checking the values of the parameters stored in the boot area 104, the data storage area 108 whether is completely formatted according to a given manner of the FAT32 storage type is acquired. When the version value is not zero, the windows operating system deems the data storage area 108 being unformatted, in this situation, the memory card 10 is taken as an un-accessible memory media by the windows operating system.

Furthermore, by way of setting the identification codes stored in the memory card 10 and the machine, the memory card 10 is limited to be accessed by a special machine. Correspondingly, the machine also is set to only access a special memory card 10. In another aspect, by way of setting the version value, an actual formatted memory card 10 may be deemed as unformatted by the operating system and thus an unauthorized machine is prohibited from accessing the memory card 10.

Furthermore, if various types of identification data between the machine and the memory card 10 are checked and confirmed to be right, the machine is permitted to perform data access to the memory card 10. In this circumstance, there is another approach to effectively protect the data stored in the memory card 10. In particular, as described above, the file allocation table 106 is used for storing the storage locations of the files and documents in the data storage area 108, therefore in order to access the data stored in the memory card 10, the machine need rely on the data stored in the file allocation table 106. Based upon this point, in one embodiment of the present invention, before accessing the data stored in the memory card 10, it is needed to firstly perform a logic calculation (e.g., exclusive or (XOR) logic operation) to the file allocation table 106 so as to obtain a decoded file allocation table via conversion. Actual storage locations of files and documents are determined by the data in the decoded file allocation table. Accordingly, even if an unauthorized machine accesses the memory card 10, it still acquires the actual content of the data stored in the memory card 10 due to the accessed data are messy at the condition of without the decoded file allocation table.

FIG. 2 is a schematic system block diagram of a memory card accessing system in accordance with one embodiment of the present invention. In the present embodiment, a machine 20 includes a processing unit 200, an identification data storage region 202, a software storage region 204 and a memory 206. Furthermore, the machine 20 further performs data access operation to a memory card 22 by an interface 210 electronically coupled with the memory card 22. The memory card 22 may be the memory card as illustrated in FIG. 1, and thus will be not repeated herein.

In the present embodiment, the machine 20 uses another operating system (e.g., a Linux operating system). Furthermore, the identification data storage region 202 is used for storing an identification data associated with the machine 20; the software storage area 204 is used for storing software for performing data access to an external memory device (e.g., the memory card 22) and/or the operating system itself. The processing unit 200 is used for loading the operating system and the above-mentioned software into the memory 206 and implementing the operating system and the software in the memory 206 to acquire the identification code (hereinafter also referred to as first identification code) as described in the foregoing embodiment from the memory card 22 and another identification code (hereinafter also referred to as second identification code) from the identification data stored in the identification data storage area 202. Thereafter, the processing unit 200 determines the machine 20 whether be able to access the memory card 22 based on whether the first and the second identification codes satisfy a predetermined relationship.

The identification data storage region 202 also stores a machine version value besides the identification code as described in the foregoing embodiment. The machine version value is another basis except the identification code for determining whether the machine 20 is permitted to access the memory card 22.

In the machine 20, since the identification data generally does not need a large storage space, in order to facilitate the data erase and program, an electrically erasable programmable read only memory (EEPROM) is used as a memory for the identification data storage region 202. In contrast, because the software and the operating system generally need a large storage space and have a little chance to be modified, an NOR flash memory is considered as a memory for the software storage region 204.

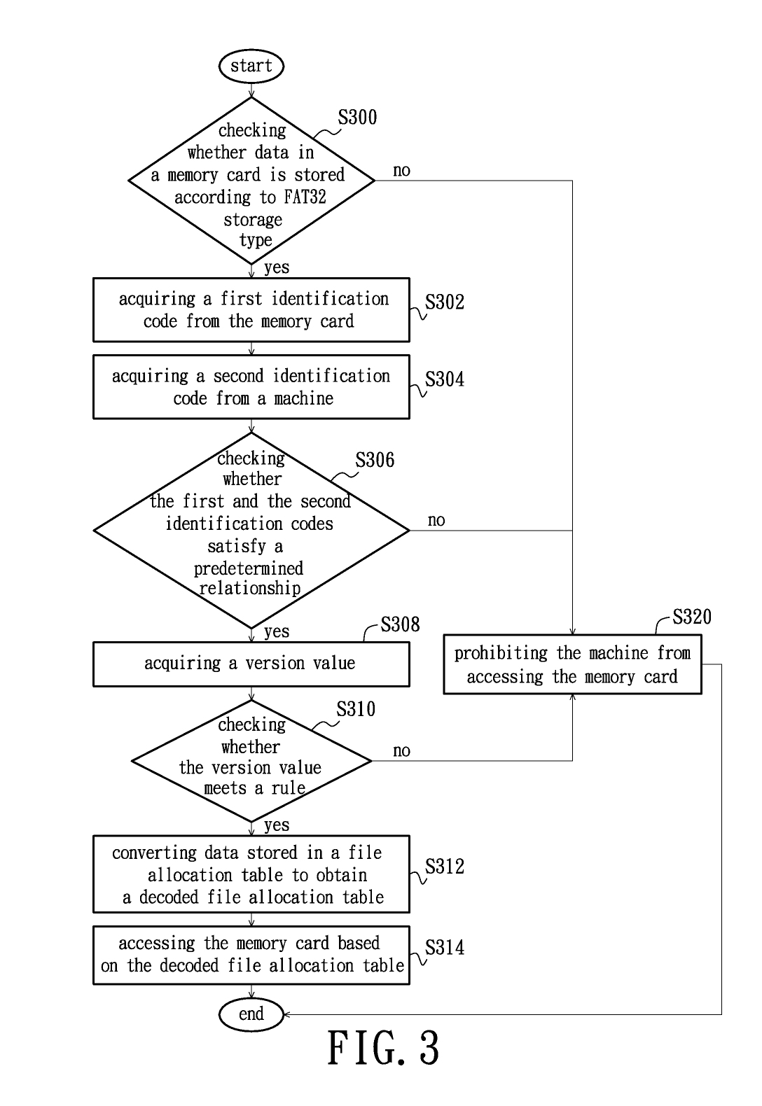

In order to describe a memory card accessing method in detail, a flow chart of the memory card accessing method in accordance with one embodiment is illustrated in FIG. 3. In the present embodiment, when a memory card is inserted into a machine, the machine firstly checks data in the inserted memory card whether is stored according to the FAT32 storage type (step S300). In particular, the machine checks a file system type value stored in the file system type storage section of the boot area 104 whether is the value of FAT32 storage type, and so on. Obviously, the FAT32 storage type mentioned herein is relative to an operating system to which the memory card is adapted, such as a windows operating system or a Linux operating system supporting the FAT32 storage type. It is understood that the operating system also may be other types of operating systems, and correspondingly the FAT32 storage type may be other suitable data storage types instead. If the data in the memory card is not stored according to the predetermined storage type (i.e., the FAT32 storage type herein), the machine is prohibited from accessing the memory card (step S320). If the data in the memory card is stored according to the predetermined storage type, the machine acquires the first identification code and the second identification code respectively from the memory card and the machine (step S302 and step S304) in sequence. The acquired first and the second identification codes then are compared with each other so as to check whether the first and the second identification codes satisfy a predetermined relationship, for example to check whether the first and the second identification codes have an operation relationship or are identical with each other (step S306). If a result in step S306 is NO, the machine still is prohibited from accessing the memory card (step S320); whereas if the result is YES, the data access determination process will go on.

In the present embodiment, if the result in step S306 is YES, the machine acquires the version value as mentioned in both the two foregoing embodiments from the memory card (step S308). The version value then is checked to determine whether it meets a rule (step S310). It is indicated that there are various approaches for confirming the version value whether meets the rule or not. For one example, setting a predetermined accessible version value in the software installed in the machine and then checking a version value obtained from the memory card and the predetermined accessible version value whether satisfy a predetermined relationship. For another example, storing an accessible version value in the identification data storage region 202 of the machine 20 of FIG. 2 and then checking the version value obtained from the memory card and the accessible version value whether satisfy a predetermined relationship. After checking, if the version value obtained from the memory card is confirmed not to meet the rule, the machine is prohibited from accessing the memory card (step S320). Whereas, if the version value obtained from the memory card is confirmed to meet the rule, the machine is permitted to access the data stored in the memory card and perform proper access operations.

In the present embodiment, the proper access operations include the steps S312 and S314. Firstly, before accessing the content of file stored in the memory card, a file allocation table is necessarily acquired and performed an operation according to a logic operation (e.g., XOR logic operation), so as to obtain a decoded file allocation table via conversion (step S312). After obtaining the decoded file allocation table, the machine (or operating system) is capable of accessing the data stored in the memory card based on the decoded file allocation table and the data is not become messy resulting from the content in the file allocation table has ever been converted/decoded (step S314).

It is indicated that, the three checking steps of S300, S306 and S310 in the present embodiment have no particular order, and even it is unnecessary all of them are performed in the data access determination process for the memory card and the machine. In other words, for one example, the step S300 may be carried out after the steps S306 and S310, the step S306 may be carried out after the step S310 or only the steps S306 and S310 of the three steps are carried out. For another example, each two steps of the three steps S300, S306 and S310 are simultaneously carried out.

In summary, in the various embodiments of the present invention, the machine and the memory card are provided with special identification data for comparison, so that the memory card only permits to be accessed by a special machine. In addition, by way of converting a file allocation table, a possibility of data which is accessed at the unauthorized state is reduced. Due to the fact that the memory card is unable to be accessed by an arbitrary machine, the risk of data leak for the memory card is greatly reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A memory card accessing method adapted to data access between a machine using a first operating system and a memory card, the memory card accessing method comprising:
checking whether data in the memory card is stored according to a data storage type supporting the first operating system, wherein a version value is recorded in the memory card and the data storage type also supports a second operation system;
prohibiting the machine from accessing the data stored in the memory card when the data in the memory card is confirmed not to be stored according to the data storage type; and
determining the memory card un-accessible for the second operating system when the second operating system confirming the version value stored in the memory card is different from a predetermined version value of the data storage type.

2. The memory card accessing method according to claim 1, further comprising:
storing a first identification code in the memory card;
storing a second identification code in the machine;
reading the first identification code by the machine to compare with the second identification code when the memory card is inserted into the machine; and
checking whether a relationship between the first identification code and the second identification code is the same as a first predetermined relationship to determine whether the machine is capable of accessing the data stored in the memory card.

3. The memory card accessing method according to claim 2, wherein the first predetermined relationship is that the first identification code is the same as the second identification code.

4. The memory card accessing method according to claim 2, wherein the memory card comprises a boot area, and the boot area is provided with a reserved storage section for storing the first identification code.

5. The memory card accessing method according to claim 1, wherein the memory card comprises a boot area, the boot area is configured for storing a plurality of parameter values for identifying the data storage type, and the parameter values comprise the version value.

6. The memory card accessing method according to claim 5, wherein the step of checking whether the data in the memory is stored according to the data storage type is relied on at least one of the parameter values stored in the boot area.

7. The memory card accessing method according to claim 5, wherein the boot area comprises a version storage section for storing the version value.

8. The memory card accessing method according to claim 1, further comprising:
acquiring the version value from the memory card;
checking whether the version value stored in the memory card meets a rule; and
permitting the machine to access the memory card when the version value stored in the memory card is confirmed to meet the rule.

9. The memory card accessing method according to claim 8, wherein the version value stored in the memory card is determined to meet the rule when the version value stored in the memory card is the same as one of accessible version values stored in the machine.

10. The memory card accessing method according to claim 1, further comprising:
converting a file allocation table stored in the memory card into a decoded file allocation table according to a logic operation when the machine is capable of accessing the data stored in the memory card; and
accessing the memory card based on a content in the decoded file allocation table.

11. A memory card accessing system, comprising:
a memory card, wherein data in the memory card is stored according to a data storage type supporting a first operating system and a first identification code is stored in the memory card; and
a machine using the first operating system, wherein the machine comprises:
a software storage region configured for storing a software which is for performing data access to an external memory device;
an identification storage region configured for storing an identification data associated with the machine; and
a processing unit configured for performing the first operating system and the software to acquire the first identification code from the memory card and a second identification code from the identification data and determining whether the machine is capable of accessing the memory card based on whether the first identification code and the second identification code satisfy a first predetermined relationship.

12. The memory card accessing system according to claim 11, wherein the data storage type supports a second operating system as well, and the memory card further comprises:
a boot area configured for storing at least one parameter value for identifying the data storage type;
a data storage area configured for storing a file; and
a file allocation table configured for storing a storage location of the file in the data storage area.

13. The memory card accessing system according to claim 12, wherein the storage location of the file in the data storage area which is stored in the file allocation table is different from an actual storage location of the file in the data storage area and is determined by a logic operation.

14. The memory card accessing system according to claim 13, wherein the logic operation comprises exclusive or logic operation.

15. The memory card accessing system according to claim 11, wherein the boot area comprises a version storage section configured for storing a version value, and when the version value is different from a predetermined version value of the data storage type, the second operating system determines the memory card un-accessible.

16. A memory card adapted to insert into a machine for accessing data stored in the memory card, wherein the data in the memory card is stored according to a data storage type supporting an operating system, the memory card comprising:
an identification data stored therein, wherein the identification data is read by the machine to compare with a machine identification data stored in the machine when the memory card is inserted into the machine, and the memory card permits the machine to access the data stored therein when the identification data and the machine identification data satisfy a predetermined relationship.

17. The memory card according to claim 16, wherein the identification data and the machine identification data respectively comprise an identification code for comparison.

18. The memory card according to claim 16, wherein the identification data comprises a version value, and when the operating system confirms the version value to be different from a predetermined version value of the data storage type, the operating system determines the memory card un-accessible.

19. The memory card according to claim 16, further comprises:
a data storage area configured for storing a file; and
a file allocation table configured for storing a storage location of the file in the data storage area, wherein the storage location of the file in the data storage area which is stored in the file allocation table is different from an actual storage location of the file in the data storage area and determined by a logic operation.

20. The memory card according to claim 19, wherein the logic operation comprises exclusive or logic operation.
